(19) United States
(12) Patent Application Publication
(10) Pub. No.: US 2026/0237033 A1
(43) Pub. Date: Aug. 13, 2026

(54) ALGORITHMS FOR 3D MODEL INPAINTING

(71) Applicant: Dell Products L.P., Round Rock, TX (US)

(72) Inventors: Zijia Wang, London (GB); Michael Robillard, Shrewsbury, MA (US); Yichun Xu, Everett, MA (US)

(21) Appl. No.: 19/052,128

(22) Filed: Feb. 12, 2025

(51) Int. Cl. G06T 5/77; G06T 7/174; G06T 19/20

(52) U.S. Cl. CPC G06T 5/77; G06T 7/174; G06T 19/20; G06T 2207/10012; G06T 2219/028

(57) ABSTRACT

One example method includes receiving a two dimensional source image of a three dimensional object, receiving a natural language text prompt, and modifying a three dimensional model of the three dimensional object according to guidance included in the natural language text prompt, and using the two dimensional source image, to obtain a modified three dimensional model. The modified three dimensional model then differs visually from the unmodified three dimensional model.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to 3D (three dimensional) modeling. More particularly, at least some embodiments relate to systems, hardware, software, computer-readable media, and methods, for leveraging text-guided 3D inpainting to modify 3D models.

### BACKGROUND

In the realm of 3D inpainting and model transformation, several companies and research groups have made significant strides. Notable among them is the work from companies like Adobe, which has developed advanced AI-based tools for 2D image manipulation, and research institutions such as Stanford University and ETH Zurich, which have contributed to the state of the art in neural rendering and 3D editing with projects. These technologies leverage neural networks to modify images or create new views but often struggle with creating consistent, realistic modifications across complex 3D objects, particularly when guided by text prompts.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a schema and algorithm, according to one embodiment.

FIG. 2 discloses aspects of a schema and technical workflow, according to one embodiment.

FIG. 3 discloses aspects of an example schema for 3D model conversion, according to one embodiment.

FIG. 4 discloses aspects of an example use case for one embodiment.

FIG. 5 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to 3D (three dimensional) modeling. More particularly, at least some embodiments relate to systems, hardware, software, computer-readable media, and methods, for leveraging text-guided 3D inpainting to modify 3D models.

One or more example embodiments comprise a method and/or schema for modification of 3D models. For example, a 3D inpainting algorithm according to one embodiment leverages the advancements of neural radiance fields (NeRFs) to achieve efficient and consistent object inpainting, providing text-guided transformations in 3D models. As used herein, ‘inpainting’ embraces, but is not limited to, techniques that may be used to modify, or fill in, missing or damaged portions of a 2D digital image, or a 3D digital model of an object, so as to restore the image or object to its complete state.

One method, according to one embodiment, may comprise operations for training a 3D model, including: generating consistent multiview segmentation masks; using the segmentation masks to segment objects that are present in a NeRF scene that was input to the 3D model; using a 2D image inpainting technique to apply desired modifications to the segmented objects to obtain inpainted images; using the inpainted images to initialize a new NeRF model; and, fine-tuning the new NeRF model. The fine-tuned NeRF model may comprise a perceptually consistent 3D model that aligns with specified creative specifications, making it an invaluable tool for digital designers and businesses.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiments is that a 3D model, such as of an object, can be inpainted using intuitive natural language (NL) text prompt. An embodiment may use a multiview consistent segmentation process to generate segment masks for identification of model portions that are/are not targets for inpainting. Various other advantages of one or more example embodiments will be apparent from this disclosure.

### A. Aspects of an Example Context for One Embodiment

The following is a discussion of aspects of a context for various embodiments. This discussion is not intended to limit the scope of the claims or this disclosure, or the applicability of the embodiments, in any way.

It is expected that immersive technology will become a key enabler of business transformation because it enables humans to interact with business information persisted in datastores, machinery represented as digital twins, and artificial intelligence easily and as equals. This idea may be referred to as the immersive enterprise. This disclosure defines an immersive enterprise as a business that leverages immersive technology to perform business transformation. This idea is aligned with what some in the industry define as spatial computing.

Within spatial or immersive environments, the ability to model and improve business processes is only constrained by the processing capabilities of the underlying infrastructure. Thus, an embodiment can leverage real-world physics, or not. An embodiment may make a simulated environment track real time operations or replay the past. Historical analysis, exploratory planning, and new product introduction all become easier. Having these capabilities available to the average business has never happened before. It has the potential to dramatically improve businesses and to reduce transactional friction.

One example embodiment, discussed elsewhere herein, is focused on the retail vertical. However, it is noted that the concepts disclosed herein are largely transferable or applicable to other verticals.

### B. Overview of Aspects of One or More Embodiments

In an embodiment, the infrastructure encompasses several key functionalities aimed at enhancing various aspects of retail operations. Firstly, rapid 3D model creation and modification is becoming increasingly important for business transformation, especially in sectors such as retail that require frequent updates to digital product designs. Thus, an algorithm according to one example embodiment leverages text-guided 3D inpainting to streamline this process, enabling businesses to transform product appearances swiftly with simple prompts and a single-image input. In an embodiment, the algorithm relies on sophisticated deep learning techniques to comprehend and apply natural language instructions to 3D models, enabling efficient and accurate visual modifications that align with the intended design specifications.

As well, the approach taken in one embodiment significantly reduces the time and effort required to modify 3D models, as compared with the time taken by traditional methods to modify a 3D model. To illustrate, a product designer can update a digital shoe model from a basic design to a ‘red trainer’ by merely providing this description, possibly in natural language (NL) form, to an embodiment of the algorithm, which handles the rest, that is, the modification of the model. This capability opens up new avenues for creative expression and rapid prototyping, aligning digital designs with dynamic market trends.

One embodiment of an algorithm has the ability to maintain visual consistency while inpainting and modifying 3D models, ensuring that the output, that is, the inpainted 3D model, is coherent and visually pleasing. An embodiment of the algorithm may achieve this by leveraging neural networks trained on a vast array of 3D shapes and textures, ensuring that the updates blend seamlessly into the existing model. In contrast with conventional approaches then, an embodiment has the ability to understand both the textual prompt and the spatial context of the 3D model, making the transformation process not only precise but also intuitive.

Finally, an embodiment may comprise a method to quickly map real-world objects into 3D models and prepare that 3D model for a relatively rapid re-design. This method may be beneficial in that it may enable designers to design without a 3D model. For example, if one cannot access a 3D model of a shoe from a website, the person can take a real shoe and generate its 3D model within several minutes, instead of having to configure a 3D model manually, which may take a long time. To generate these ‘quick’ 3D models, an embodiment may comprise a method that includes mounting multiple stereoscopic cameras to capture images from 5 different sides. After capturing the 2D images from each side of the object, an embodiment may then map the 2D images a 3D model. Because this process leverages more on computer vision processing than AI algorithms, this approach is relatively lightweight in terms of the amount of time and computing resources needed, and thus can be deployed at an edge device at a relatively low cost.

### C. Detailed Discussion of Aspects of an Embodiment

### C.1 Introduction

By way of overview, and comparison with conventional approaches, an embodiment may leverage text-guided 3D inpainting to modify 3D models swiftly and accurately, setting it apart from existing solutions. Unlike conventional methods that rely heavily on user intervention for segmenting and editing models, an approach according to one embodiment combines natural language processing with advanced neural networks to automate much of this process. This approach may ensure visual consistency by intelligently blending new design elements with existing textures, achieving seamless transformations that closely align with the intended creative vision. This results in a more efficient workflow and a powerful tool for digital designers and businesses looking to innovate in immersive technology.

As stated, immersive technology has emerged as an enabler for business transformation, allowing for seamless interaction with digital models of physical assets. Businesses can leverage immersive environments to enhance processes with simulations, historical analysis, and product innovation.

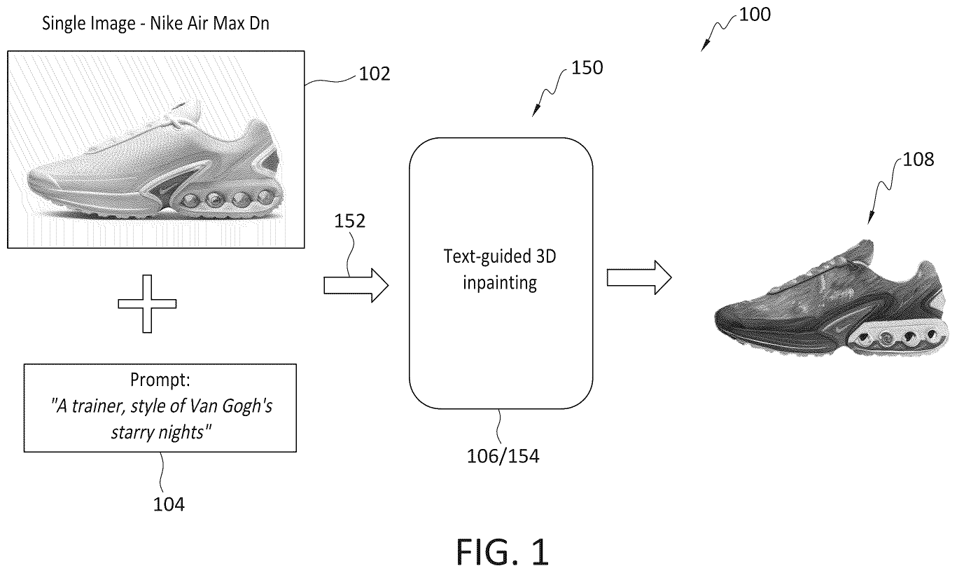

With attention now to the example of FIG. 1, an example overall schema 100 and method 150 according to one embodiment are disclosed. As shown there, an image 102 and a prompt 104 may be input 152 to an algorithm 106, according to one embodiment, which may then create 154 a 3D model 108 of the shoe, modified as specified in the prompt 104.

Within this context, efficiently creating 3D models of retail products such as shoes may be important for immersive enterprises. However, current 3D model creation methods often face limitations in quickly updating product appearances. The 3D inpainting algorithm according to one embodiment addresses this challenge by allowing for rapid re-designs of product models through text prompts and single-image inputs, as demonstrated in the example of FIG. 1. The algorithm enables efficient 3D model updates by modifying the appearance of existing models with natural language prompts, such as ‘a red trainer.’ An embodiment thus has the ability to leverage text-guided 3D inpainting, which efficiently modifies product models, making it an indispensable tool for businesses aiming to streamline their digital product design process.

Thus, an embodiment may comprise an algorithm that significantly enhances the creation and modification of digital 3D models, which may be useful in immersive environments. Further, such an algorithm transforms product design by enabling swift updates to 3D models, such as footwear, through simple text prompts and single-image inputs, enhancing efficiency in digital transformation. Terms like text-guided 3D inpainting emphasize the importance of natural language for digital design, which can be important in fields such as retail where rapid product visualization is needed. The technology can streamline product design workflows, exemplified by the rapid redesign of shoes, making digital twins more responsive to market demands. An embodiment may use deep learning models to intelligently modify model appearances, thereby providing precision and flexibility in design.

### C.2 Discussion

One example embodiment may comprise various capabilities. Examples of such capabilities include, but are not limited to:
1. [PROCESS, INFRA, ALGO FLOW] The ability to redesign a product, such as shoes for example, in a 3D way by inputting, to a 3D model, (1) a single image and (2) a text prompt.
2. [PROCESS, INFRA, ALGO FLOW] An algorithm with the ability to maintain visual consistency while inpainting and modifying 3D models, ensuring the output is coherent and visually pleasing
3. [PROCESS, INFRA, ALGO FLOW] A system that includes stereoscopic cameras to quickly generate a 3D model from real object.

A 3D inpainting algorithm according to one embodiment leverages the advancements of neural radiance fields (NeRFs) to achieve efficient and consistent object inpainting, providing text-guided transformations in 3D models. One embodiment of the method, which may be influenced by the principles of InNeRF360, may overcome the challenges inherent in modifying 3D models, such as maintaining visual consistency and eliminating artifacts across different views.

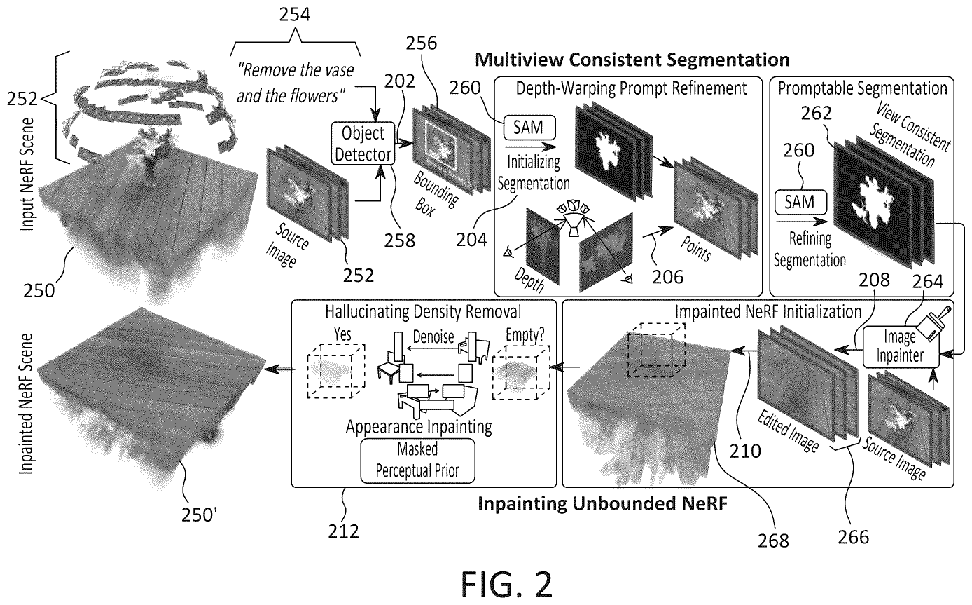

As shown in the example of FIG. 2, model 250 may be identified that is to be inpainted. In this case, the model 250 comprises a vase of flowers on a table, denoted as the ‘Input NeRF Scene.’ In an embodiment, the model 250 may be obtained by generating images 252, for example, through the use of stereoscopic cameras that are able to record depth. One of the images 252 may be used as an input to an inpainting process 200 according to an embodiment. One embodiment may only require a single image 252 to support an inpainting process. Another input to the inpainting process 200 is a prompt 254. In the example of FIG. 2, the prompt 254, which may be a textual prompt rendered in natural language (NL), is ‘Remove the vase and the flowers.’ Thus, the task of the example inpainting process 200, carried out by an embodiment of an inpainting algorithm, is to modify—based on the two inputs—the model 250 by removing the vase and the flowers, so as to produce the final model 250′ in which the vase and flowers no longer appear.

The process 200 may begin with the generation of multiview-consistent segmentation masks, that is, segmentation masks that are consistent across multiple different views, or images, of an object. In general, a segmentation mask may comprise one or more bounding boxes 256, each of which bounds a respective feature of the image 252 that is to be modified, or in this example case, removed. As shown, an object detector 258 may be used to identify these portions, and then output a set of bounding boxes 256 that correspond to various features of the image 252. In this case, a bounding box may be generated for the flowers, and another bounding box for the vase, or a single bounding box may be generated that encompasses both the vase and the flowers.

In an embodiment, generation of the multiview-consistent segmentation masks may be achieved by initializing segmentations 204 using a segmentation model 260 such as SAM (Segment Anything Model) with bounding boxes 256 derived from a text prompt 254.

These bounding boxes 256 often contain inaccuracies, so an embodiment may refine 206 the bounding boxes 256, possibly using a model 260 such as SAM, by leveraging depth information derived from the model 250 and/or the images 252. In an embodiment, the refinement 206 of the bounding boxes 256 may comprise using depth-space warping to align the 3D points within the image, ensuring accurate segmentation masks 262 that are consistent across multiple views.

Once segmentation masks 262 are established, a 2D image inpainting technique 264 may be used to apply 208 the desired modifications to the segmented objects of the source image 252 so as to generate an inpainted image 266. The inpainted images 266 are then used to initialize 210 a new NeRF model 268, which may be further refined 212 using geometric priors from a 3D diffusion model. This approach may ensure accurate texture application and may eliminate artifacts that arise from inconsistent 2D inpainting.

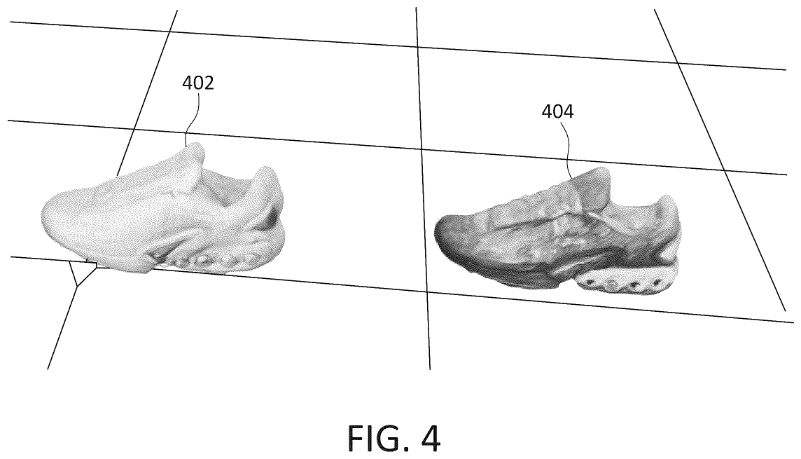

In more detail, in this final stage, the new NeRF model 268 is fine-tuned using perceptual priors to ensure visual consistency. An embodiment of the algorithm applies pixel and perceptual loss functions to minimize discrepancies between the inpainted model 268 and original model 250, creating seamless modifications, and producing the final model 250′. This approach enables intuitive design transformations based on simple text prompts, such as ‘a red trainer’ or ‘a trainer, style of Van Gogh's starry nights,’ as shown in the images in FIG. 4, discussed below. The result is a perceptually consistent 3D model 250′ that aligns with the desired creative specifications, making it an invaluable tool for digital designers and businesses.

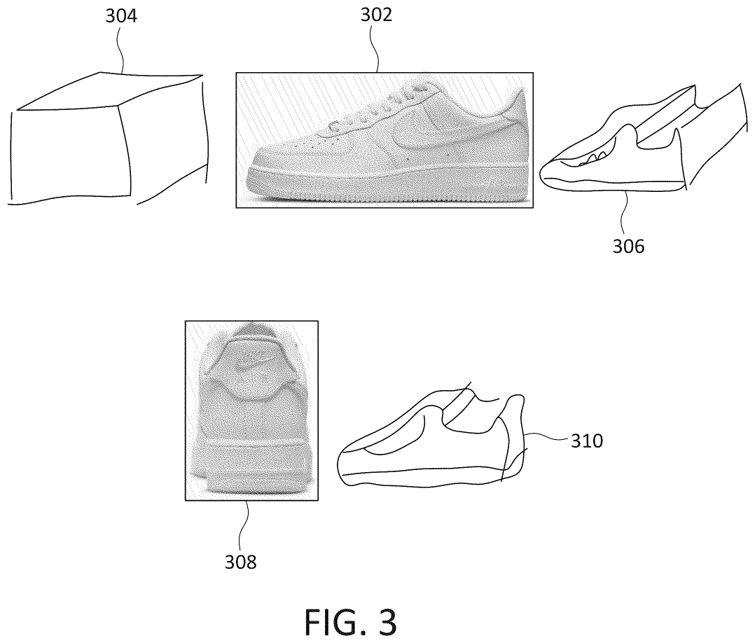

It is noted that a way to think about the process disclosed in FIG. 2 is that the inpainting pipeline is realized by training, or fine-tuning, a new NeRF model on the edited data. That is, although FIG. 2 describes all the steps involved in “taking out an object” and then “filling in” the missing parts, this process can be understood as training a neural field to reflect those edits. In other words:
1. Segmentation and Inpainting: create edited (inpainted) 2D images.
2. NeRF Initialization and Fine-Tuning: the edited images become training data for a new or updated NeRF—the radiance field is trained/optimized so that it learns the edited appearance in 3D, rather than simply splicing in 2D edits.
   Hence, FIG. 2 is presented as an “inpainting” pipeline, but it is important to note that a new radiance field is trained around the inpainted views and, as such, the process disclosed in FIG. 2 may be referred to as a “training process.”
   C.3 3D model creation

Where a 3D model to be inpainted does not already exist, an example embodiment may be used to create one. One example approach for 3D model creation is disclosed in FIG. 3. In particular, for 3D model creation, a small space may be set up and the object to be modeled placed in the space. The space may include, for example, 5 stereoscopic cameras that view the object from different respective angles, or perspectives. Respective cameras may capture, as images, each individual side of the object. Those images, when combined with depth information also captured by the cameras, may be used to create a 3D model.

Turning now to the example of FIG. 3, a shoe is to be modeled. When a picture 302 of the side of the shoe is fed into a rendering system, a 3D model 304 will be cut using that picture to shape the model as shown at 306. Similarly, the model 306 may be further refined using a picture 308 taken at the back of the shoe so that the model then assumes the configuration shown at 310. With various images of the shoe taken and inputted one by one, the details of the 3D model may be further refined. After all pictures are inputted, a 3D model that looks like exactly the real shoe will be generated.

### D. Further Discussion

As disclosed herein, embodiments may possess various useful features and aspects, although no embodiment is required to possess any of such features or aspects. The following examples are illustrative, but not exhaustive.

One embodiment of an algorithm comprises the concept of text-guided 3D inpainting, an approach that enables intuitive transformation of 3D models using natural language prompts. This aspect leverages advanced natural language processing and neural network capabilities to modify existing 3D models rapidly, making the process more accessible and efficient for designers. By translating textual descriptions into visual changes, an algorithm according to one embodiment significantly reduces the manual effort required for 3D model updates, enabling quick iterations and creative exploration.

An embodiment may comprise a method that includes the use of multiview consistent segmentation achieved through depth-space warping. This method ensures that the segmentation masks generated are accurate and consistent across multiple views, eliminating the artifacts that typically arise from inconsistent segmentation in 3D inpainting. This refinement in segmentation, combined with geometric priors and perceptual loss functions, ensures that modifications blend seamlessly into the existing 3D models, delivering visually coherent transformations that align with the desired design specifications.

An embodiment may employ pictures of an object, taken from multiple different perspectives by stereoscopic cameras, to generate a 3D model. An embodiment of such a method uses stereoscopic cameras, so they can capture the unevenness of each side with its distance measurement capability, thus resulting in an accurate 3D model. This method turns real world objects into 3D models in an automatic and efficient way.

### E. Example Use Cases

The following use cases are provided solely for the purpose of illustration. They are not intended to limit the scope of this disclosure, or of any claims, in any way.

With reference now to FIG. 4, an illustrative example of the operation of an embodiment is disclosed. There, an embodiment has converted an original white trainer into a trainer with the appearance of Van Gogh's ‘Starry Night’ painting in the 3D space. The model 402 of the white trainer may be generated using images of the actual white trainer shoe. Then, an embodiment may implement a relatively quick redesign, about five minutes in the example of FIG. 4, of the model 402, based on an input prompt such as ‘trainer, style of Van Gogh ‘Starry Nights’.’ The redesigned model is shown at 404 with the ‘Van Gogh’ features incorporated.

This approach may enable designers to find inspiration and enhance the efficiency for their work. Although the example uses pictures of shoes, the general approach may be applied in many other merchandise designs including, but not limited to, gaming computers for example.

As another example, an embodiment of the method may be used to offer personalized design experience for customers. For example, a store can set up a design experience kiosk or something similar to advertise their brand and attract more customers. Since an embodiment enables quick design, sometimes within several minutes per customer, this approach may enable many customers to generate designs. As well, an embodiment may add more revenue because customers are often willing to pay for personalized items.

### F. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### G. Further Example Embodiments

Following are some further example embodiments. These are presented only by way of example and are not intended to limit the scope of this disclosure or the claims in any way.

Embodiment 1. A method, comprising: receiving a two dimensional source image of a three dimensional object; receiving a natural language text prompt; and modifying a three dimensional model of the three dimensional object according to guidance included in the natural language text prompt, and using the two dimensional source image, to obtain a modified three dimensional model.

Embodiment 2. The method as recited in any preceding embodiment, wherein the natural language text prompt is received from a human user.

Embodiment 3. The method as recited in any preceding embodiment, wherein the two dimensional source image was created with a stereoscopic camera.

Embodiment 4. The method as recited in any preceding embodiment, wherein the three dimensional model was created using two dimensional images of the three dimensional object captured by one or more stereoscopic cameras.

Embodiment 5. The method as recited in any preceding embodiment, wherein the modifying comprises inpainting of the three dimensional model.

Embodiment 6. The method as recited in any preceding embodiment, wherein the modified three dimensional model comprises a visual change relative to the three dimensional model.

Embodiment 7. The method as recited in any preceding embodiment, wherein the modifying comprises: generating consistent multiview segmentation masks for the two dimensional source image; and using the consistent multiview segmentation masks, applying a two dimensional inpainting process to the three dimensional model.

Embodiment 8. The method as recited in embodiment 7, wherein generating consistent multiview segmentation masks comprises generating one or more bounding boxes for the two dimensional source image.

Embodiment 9. The method as recited in embodiment 7, wherein the consistent multiview segmentation masks are accurate and consistent across multiple views of the three dimensional object.

Embodiment 10. The method as recited in any preceding embodiment, further comprising refining the modified three dimensional model by applying pixel and perceptual loss functions to minimize discrepancies between the modified three dimensional model and the three dimensional model.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

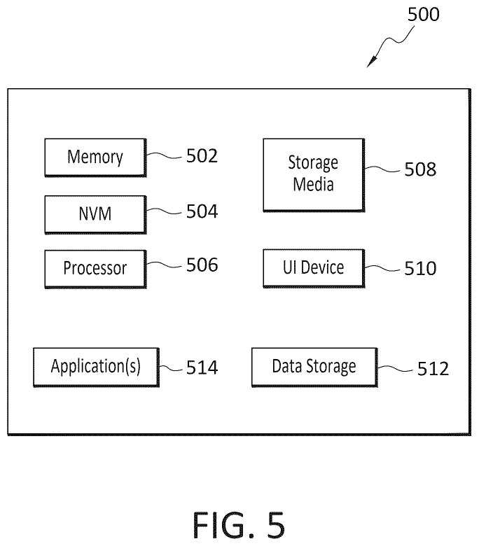

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving a two dimensional source image of a three dimensional object;
receiving a natural language text prompt; and
modifying a three dimensional model of the three dimensional object according to guidance included in the natural language text prompt, and using the two dimensional source image, to obtain a modified three dimensional model.

2. The method as recited in claim 1, wherein the natural language text prompt is received from a human user.

3. The method as recited in claim 1, wherein the two dimensional source image was created with a stereoscopic camera.

4. The method as recited in claim 1, wherein the three dimensional model was created using two dimensional images of the three dimensional object captured by one or more stereoscopic cameras.

5. The method as recited in claim 1, wherein the modifying comprises inpainting of the three dimensional model.

6. The method as recited in claim 1, wherein the modified three dimensional model comprises a visual change relative to the three dimensional model.

7. The method as recited in claim 1, wherein the modifying comprises:
generating consistent multiview segmentation masks for the two dimensional source image; and
using the consistent multiview segmentation masks, applying a two dimensional inpainting process to the three dimensional model.

8. The method as recited in claim 7, wherein generating consistent multiview segmentation masks comprises generating one or more bounding boxes for the two dimensional source image.

9. The method as recited in claim 7, wherein the consistent multiview segmentation masks are accurate and consistent across multiple views of the three dimensional object.

10. The method as recited in claim 1, further comprising refining the modified three dimensional model by applying pixel and perceptual loss functions to minimize discrepancies between the modified three dimensional model and the three dimensional model.

11. A non-transitory storage medium having stored therein instructions that are executable by one or more hardware processors to perform operations comprising:
receiving a two dimensional source image of a three dimensional object;
receiving a natural language text prompt; and
modifying a three dimensional model of the three dimensional object according to guidance included in the natural language text prompt, and using the two dimensional source image, to obtain a modified three dimensional model.

12. The non-transitory storage medium as recited in claim 11, wherein the natural language text prompt is received from a human user.

13. The non-transitory storage medium as recited in claim 11, wherein the two dimensional source image was created with a stereoscopic camera.

14. The non-transitory storage medium as recited in claim 11, wherein the three dimensional model was created using two dimensional images of the three dimensional object captured by one or more stereoscopic cameras.

15. The non-transitory storage medium as recited in claim 11, wherein the modifying comprises inpainting of the three dimensional model.

16. The non-transitory storage medium as recited in claim 11, wherein the modified three dimensional model comprises a visual change relative to the three dimensional model.

17. The non-transitory storage medium as recited in claim 11, wherein the modifying comprises:
generating consistent multiview segmentation masks for the two dimensional source image; and
using the consistent multiview segmentation masks, applying a two dimensional inpainting process to the three dimensional model.

18. The non-transitory storage medium as recited in claim 17, wherein generating consistent multiview segmentation masks comprises generating one or more bounding boxes for the two dimensional source image.

19. The non-transitory storage medium as recited in claim 17, wherein the consistent multiview segmentation masks are accurate and consistent across multiple views of the three dimensional object.

20. The non-transitory storage medium as recited in claim 11, further comprising refining the modified three dimensional model by applying pixel and perceptual loss functions to minimize discrepancies between the modified three dimensional model and the three dimensional model.
